(19) United States
(12) Patent Application Publication
(10) Pub. No.: US 2025/0223235 A1
(43) Pub. Date: Jul. 10, 2025

(54) LAMINATE, ANTENNA-IN-PACKAGING, AND METHODS OF MAKING THE SAME

(71) Applicant: CORNING INCORPORATED, CORNING, NY (US)

(72) Inventors: Ryan Cadwell, Corning, NY (US); Cheolbok Kim, Painted Post, NY (US); Anthony Ng'oma, Horseheads, NY (US)

(21) Appl. No.: 18/980,556

(22) Filed: Dec. 13, 2024

Related U.S. Application Data
(60) Provisional application No. 63/618,033, filed on Jan. 5, 2024.

(51) Int. Cl. C04B 37/00; H01Q 1/22; H01Q 1/38

(52) U.S. Cl. CPC C04B 37/006; H01Q 1/2283; H01Q 1/38; C04B 2235/3217; C04B 2235/94; C04B 2237/12; C04B 2237/343; C04B 2237/555

(57) ABSTRACT

Laminates and antenna-in-packaging include a plurality of substrates and a plurality of metallic traces disposed between adjacent pairs of substrates and extending through one or more vias in at least one substrate. An adjacent pair of metallic traces electrically connected through the one or more vias. The adjacent pair of substrates are bonded together by at least the metallic trace positioned therebetween. A metallic material of the plurality of metallic traces has an electrical conductivity at 20° C. of about 10⁵ S/m or more. Methods include disposing a first metallic trace on a first substrate followed by disposing a second substrate thereon and then disposing a second metallic traces thereon before heating the resulting assembly to form the laminate with the substrates bonded together by at least the metallic trace. Disposing the metallic trace can include disposing a conductive ink, for example, by aerosol jet printing.

This application claims the benefit of priority under 35 U.S.C. § 119 of U.S. Provisional Application Ser. No. 63/618,033, filed on Jan. 5, 2024, the content of all of which is relied upon and incorporated herein by reference in its entirety.

### TECHNICAL FIELD

The present disclosure relates to laminates, antenna-in-packaging, and methods of making the same, and more particularly, to a laminates and antenna-in-packaging having a plurality of substrates and a plurality of metallic traces disposed therebetween and methods of making the same.

### BACKGROUND

Electronic devices can communicate wirelessly using antennas. Increasingly, consumer electronic devices require reliable wireless connectivity. Consumer electronic devices can include display devices, for example, liquid crystal displays (LCDs), electrophoretic displays (EPD), organic light-emitting diode displays (OLEDs), plasma display panels (PDPs), or the like. Further, the demand for electronic devices with increased bandwidth of wireless communication has pushed the operating frequencies higher and higher, corresponding to smaller and smaller electronic components. For example, electronic devices can communicate wirelessly in the millimeter wave (mmWave), 5G, 6G, and/or sub-teraHertz (sub-THz) bands. As components get smaller, tolerances for the alignment of such components get more precise, which can complicate manufacturing and/or processing. Consequently, there is a need for a method of making electronic components that simplify manufacturing and/or assembly of components and the resulting consumer electronic devices.

### SUMMARY

The present disclosure provides laminates, antenna-in-packaging, and method of making the same. Laminates include a metallic trace (of a plurality of metallic traces) at least partially bonded together an adjacent pair of substrates (of a plurality of substrates). Having the metallic trace (at least partially) bond the laminate together while simultaneously providing electrical communication through the laminate can simplify manufacturing and/or reduce material costs associated with the laminate. Consequently, laminates can combine multiple electronic components in a single package, which can simplify manufacturing and/or assembly of electronic devices (e.g., consumer electronic devices). Laminates can provide good electrical conductivity (through the plurality of metallic traces) between an antenna (that can be part of the laminate) and additional electronic components, which can be used for communication in the millimeter wave (mmWave), 5G, 6G, and/or sub-teraHertz (sub-THz) band(s) with low losses (e.g., low dielectric loss tangents). For example, substrates of the plurality of substrates can be alumina ribbon ceramics. Additionally, having an antenna as part of the laminate (as antenna-in-packaging) can facilitate assembly (e.g., reducing the number of components that need to be precisely aligned in final assembly of a consumer electronic device) and/or facilitate miniaturization of the electronic components (including increasing an operating frequency to within one or more of the above-mentioned bands). Optionally, the laminate can further include a dielectric layer that can provide environmental resistance (e.g., moisture resistance and/or chemical resistance) to the metallic traces, for example, to enable reliable operation in harsh environments.

Methods of making the laminate (e.g., antenna-in-packaging) can alternately disposing a metallic trace on a substrate (and with one or vias in the substrate) and disposing another substrate thereon. In aspects, disposing the metallic trace can comprise disposing a conducting ink that is subsequently heated to form electrical connection through the laminate as well as (at least partially) bond the substrates (e.g., adjacent pairs of substrates) in the laminate together. In aspects, disposing the metallic trace can comprise aerosol jet printing and/or metal organic decomposition to provide a dense metallic trace, high electrical conductivity, and/or a distinctive microstructure.

Some example aspects of the disclosure are described below with the understanding that any of the features of the various aspects may be used alone or in combination with one another.

Aspect 1. A laminate comprising:
a plurality of substrates, a substrate material of the plurality of substrates comprising an electrical conductivity at 20° C. of about 10 S/m or less;
a plurality of metallic traces disposed between adjacent pairs of substrates of the plurality of substrates and extending through one or more vias in at least one substrate in the adjacent pairs of substrates, an adjacent pair of metallic traces electrically connected through the one or more vias through a corresponding substrate of the plurality of substrates, a metallic material of the plurality of metallic traces comprising an electrical conductivity at 20° C. of about 10⁵ S/m or more,
wherein the adjacent pairs of substrates are bonded together by at least a metallic trace positioned therebetween.

Aspect 2. The laminate of aspect 1, wherein a substrate thickness a substrate of the plurality of substrates is from about 10 micrometers to about 800 micrometers.

Aspect 3. The laminate of any one of aspects 1-4, further comprising a plurality of dielectric layers, a dielectric layer of the plurality of dielectric layers positioned between a corresponding adjacent pair of substrates, a dielectric material of the plurality of dielectric layers comprising an electrical conductivity at 20° C. of about 0.1 S/m or less;
and at least one of:
   the dielectric layer contacting a corresponding metallic trace; or
   the dielectric layer positioned at a peripheral location between the corresponding adjacent pair of substrates.

Aspect 4. A laminate comprising:
a plurality of substrates including a first substrate and a second substrate, a substrate material of the plurality of substrates comprising an electrical conductivity at 20° C. of about 10 or less;
a plurality of metallic traces including a first metallic trace, a second metallic trace, and a via, the first metallic trace disposed on the first substrate, the second metallic trace disposed on the second substrate, the via electrically connecting the first metallic trace and the second metallic trace through the second substrate, a metallic material of the plurality of metallic traces comprising an electrical conductivity at 20° C. of about 10⁵ S/m or more,
wherein the first substrate and the second substrate are bonded together by at least the first metallic trace.

Aspect 5. The laminate of aspect 4, wherein a substrate thickness of the second substrate is from about 10 micrometers to about 800 micrometers.

Aspect 6. The laminate of any one of aspects 4-5, further comprising a plurality of dielectric layers, a dielectric layer of the plurality of dielectric layers positioned between the first substrate and the second substrate, a dielectric material of the plurality of dielectric layers comprising an electrical conductivity at 20° C. of about 0.1 S/m or less;
and at least one of:
   the dielectric layer contacting the first metallic trace; or
   the dielectric layer positioned at a peripheral location between the first substrate and the second substrate.

Aspect 7. The laminate of aspect 2 or aspect 5, wherein the substrate thickness is from about 20 micrometers to about 100 micrometers.

Aspect 8. The laminate of aspect 3 or aspect 6, wherein the plurality of dielectric layers comprises an adhesive.

Aspect 9. The laminate of aspect 3, aspect 6, or aspect 8, wherein the dielectric material comprises a dielectric loss tangent of about 0.01 or less at 20° C. and 20 GHz.

Aspect 10. The laminate of any one of aspects 1-9, wherein the metallic material of the plurality of metallic traces comprises copper, silver, gold, aluminum, nickel, platinum, or alloys with or without conductive carbon or combinations thereof.

Aspect 11. The laminate of any one of aspects 1-10, wherein the electrical conductivity of the metallic material in the plurality of metallic traces comprises at 20° C. is from about 5×10⁶ S/m to about 10⁹ S/m.

Aspect 12. The laminate of any one of aspects 1-11, wherein an average grain size of the metallic material of the plurality of metallic traces is from about 10 nm to about 800 nm.

Aspect 13. The laminate of any one of aspects 1-12, wherein the electrical conductivity of the substrate material at 20° C. is about 10⁻⁶ S/m or less.

Aspect 14. The laminate of any one of aspects 1-13, wherein the substrate material exhibits a dielectric loss tangent of about 0.01 or less at 20° C. and 20 GHz.

Aspect 15. The laminate of any one of aspects 1-14, wherein the substrate material comprises a ceramic-based material.

Aspect 16. The laminate of any one of aspects 1-15, wherein the substrate material comprises alumina, zirconia, steatite, quartz, or a glass-based material.

Aspect 17. The laminate of any one of aspects 1-16, wherein the plurality of substrates comprises 5 or more substrates.

Aspect 18. The laminate of any one of aspects 1-17, wherein the plurality of metallic traces include an antenna configured to receive or transmit signals comprising a frequency from about 20 GHz to about 400 GHz.

Aspect 19. The laminate of aspect 18, wherein the plurality of metallic traces further comprises a ground, the plurality of metallic traces further configured to transmit the signals between an integrated circuit and the antenna, the ground positioned between the integrated circuit and the antenna.

Aspect 20. The laminate of any one of aspects 1-14, wherein the plurality of metallic traces is configured to transmit signals between an integrated circuit and an antenna, the plurality of metallic traces further comprising a ground positioned between the integrated circuit and the antenna.

Aspect 21. An consumer electronic device comprising:
an antenna-in-packaging comprising the laminate of any one of aspects 1-19;
an integrated circuit in electrical contact with the antenna of the laminate through the plurality of metallic traces, and a ground of the laminate positioned between the integrated circuit and the antenna of the laminate.

Aspect 22. A consumer electronic device comprising:
a housing comprising a front surface, a back surface, and a side surface; and
electrical components at least partially within the housing, the electrical components comprise a controller, a memory, and a display, the display at or facing the front surface of the housing,
wherein at least one of the electrical components or the housing includes the laminate of any one of aspects 1-21.

Aspect 23. A method of making a laminate comprising:
disposing a first metallic trace on a first substrate;
disposing a second substrate on the first metallic trace;
disposing a second metallic trace on the second substrate and within a via in the second substrate; and
heating an assembly comprising at least the first substrate, the second substrate, the first metallic trace, and the second metallic trace to form the laminate with the first substrate bonded to the substrate by at least the first metallic trace, and the first metallic trace in electrical contact with the second metallic trace,
wherein a substrate material of at least one of the first substrate or the second substrate comprises an electrical conductivity at 20° C. of about 10 S/m or less, a metallic material of at least one of the first metallic trace or the second metallic trace comprises an electrical conductivity at 20° C. of about 10⁵ S/m or more, and the disposing the first metallic trace and the second metallic trace comprises disposing a conductive ink that forms the corresponding metallic trace.

Aspect 24. The method of aspect 23, wherein the metallic material comprises copper, silver, gold, aluminum, nickel, platinum, or alloys with or without conductive carbon or combinations thereof.

Aspect 25. The method of any one of aspects 23-24, wherein the electrical conductivity of the metallic material comprises at 20° C. is from about 5×10⁶ S/m to about 10⁹ S/m.

Aspect 26. The method of any one of aspects 23-25, wherein an average grain size of the metallic material of the plurality of metallic traces is from about 10 nm to about 800 nm.

Aspect 27. The method of any one of aspects 23-26, wherein the disposing the first metallic trace comprises ink-jet printing, aerosol jet printing, brushing, or combinations thereof.

Aspect 28. The method of any one of aspects 23-27, wherein the disposing the first metallic trace comprises aerosol jet printing.

Aspect 29. The method of any one of aspects 27-28, wherein the disposing the first metallic trace further comprises metal organic decomposition.

Aspect 30. The method of any one of aspects 23-29, wherein the disposing the first metallic trace occurs at a first temperature from about 60° C. to about 350° C.

Aspect 31. The method of claim 30, wherein the first temperature is from about 70° C. to about 100° C.

Aspect 32. The method of any one of aspects 23-31, wherein the heating the assembly comprises heating the assembly at a second temperature from about 150° C. to about 350° C. for a second period of time from about 10 minutes to about 3 hours.

Aspect 33. The method of any one of aspects 23-31, wherein the heating the assembly comprises heating the assembly at a second temperature from about 500° C. to about 750° C. for a second period of time from about 10 minutes to about 3 hours.

Aspect 34. The method of any one of aspects 23-33, further comprising, before disposing the second substrate, disposing a dielectric layer on the first substrate, a dielectric material of the dielectric layer comprises an electrical conductivity at 20° C. of about 0.1 S/m or less.

Aspect 35. The method of aspect 34, wherein the dielectric layer further contacts the first metallic trace.

Aspect 36. The method of any one of aspects 34-35, wherein the dielectric layer is positioned at a peripheral location of the first substrate.

Aspect 37. The method of any one of aspects 34-36, wherein the plurality of dielectric layers comprises an adhesive.

Aspect 38. The method of any one of aspects 34-37, wherein the dielectric material comprises a dielectric loss tangent of about 0.01 or less at 20° C. and 20 GHz.

Aspect 39. The method of any one of aspects 23-38, wherein a substrate thickness of the second substrate is from about 10 micrometers to about 800 micrometers.

Aspect 40. The method of aspect 39, wherein the substrate thickness is from about 20 micrometers to about 100 micrometers.

Aspect 41. The method of any one of aspects 23-40, wherein the electrical conductivity of the substrate material at 20° C. is about 10⁻⁶ S/m or less.

Aspect 42. The method of any one of aspects 23-41, wherein the substrate material exhibits a dielectric loss tangent of about 0.01 or less at 20° C. and 20 GHz.

Aspect 43. The method of any one of aspects 23-42, wherein the substrate material comprises a ceramic-based material.

Aspect 44. The method of any one of aspects 23-43, wherein the substrate material comprises alumina, zirconia, steatite, quartz, or a glass-based material.

Aspect 45. An consumer electronic device comprising:
an antenna-in-packaging comprising the laminate produced by the method of any one of aspects 20-41, wherein the plurality of metallic traces include an antenna configured to receive or transmit signals comprising a frequency from about 20 GHz to about 400 GHz.
an integrated circuit in electrical contact with the antenna of the laminate through the plurality of metallic traces, and a ground of the laminate positioned between the integrated circuit and the antenna of the laminate.

Aspect 46. A consumer electronic device comprising:
a housing comprising a front surface, a back surface, and a side surface; and
electrical components at least partially within the housing, the electrical components comprise a controller, a memory, and a display, the display at or facing the front surface of the housing,
wherein at least one of the electrical components or the housing includes the laminate produced by the method of any one of aspects 23-45.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic cross-sectional view of a laminate with a metallic traces between substrates in accordance with aspects of the present disclosure;

FIG. 2 is a schematic cross-sectional view of another laminate with dielectric material and a metallic trace between substrates in accordance with aspects of the present disclosure;

FIG. 3 is a flowchart of a method of forming the laminate shown in FIG. 1 or FIG. 2 in accordance with aspects of the present disclosure;

FIG. 4 schematically illustrates a step of methods comprising forming a slip for a green tape in accordance with aspects of the present disclosure;

FIG. 5 schematically illustrates a temperature profile for firing a green tape in accordance with aspects of the present disclosure;

FIG. 6 schematically illustrates a temperature profile comprising a plurality of heating steps for firing a green tape in accordance with aspects of the present disclosure;

FIG. 7 schematically illustrates a step of firing a green tape in accordance with aspects of the present disclosure;

FIG. 8 schematically illustrates a step of methods comprising forming a slip for a green tape in accordance with aspects of the present disclosure;

FIG. 9 schematically illustrates a temperature profile for firing a green tape in accordance with aspects of the present disclosure;

FIG. 10 is a schematic plan view of an example consumer electronic device according to aspects;

FIG. 11 is a schematic perspective view of the example consumer electronic device of FIG. 10;

FIG. 12 schematically illustrates a back view of a consumer electronic device including the laminate as antenna-in-packaging in accordance with aspects of the present disclosure; and

FIG. 13 schematically illustrates a cross-sectional view of a laminate as antenna-in-packaging as part of a consumer electronic device in accordance with aspects of the present disclosure.

### DETAILED DESCRIPTION

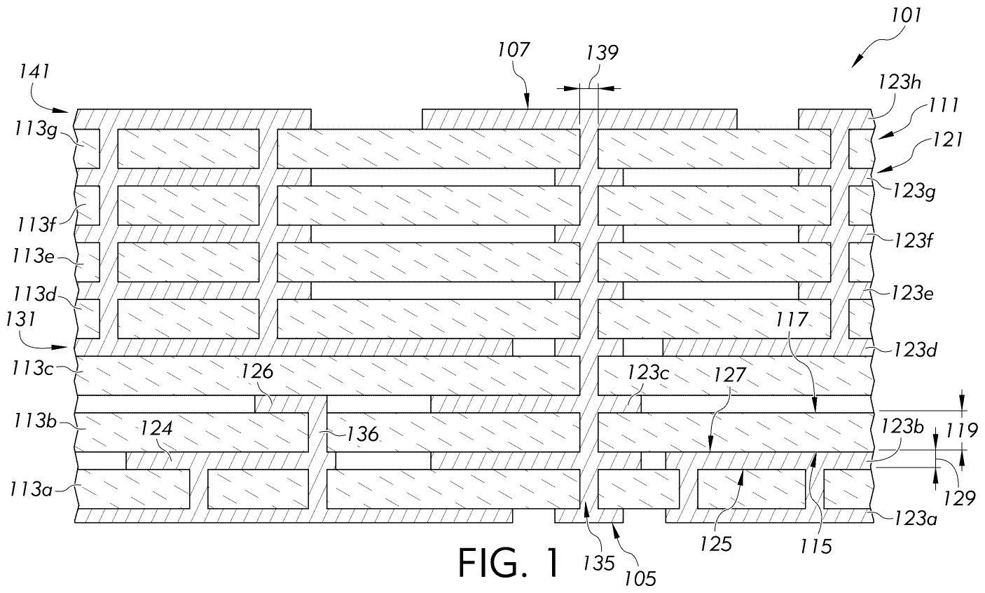

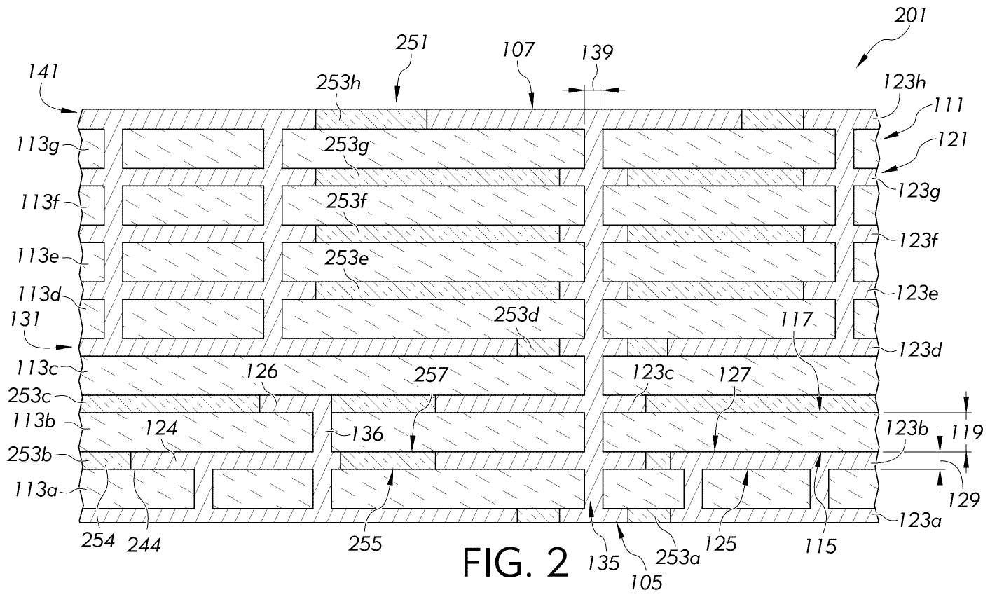

FIGS. 1-2 schematically shows laminates 101 and 201 comprising a plurality of substrates 111 and a plurality of metallic traces 121 electrically connected through vias 135. The laminate 201 shown in FIG. 2 further comprises one or more dielectric layers 253a-253h. The laminates can be part of a consumer electronic product, for example, functioning as antenna-in-packaging. Unless otherwise noted, a discussion of features of aspects of one laminate, metallic trace, and/or substrate can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIGS. 1-2, the laminate 101 or 201 comprises a plurality of substrates 111 including substrates 113a-113g. With reference to substrate 113b, the substrate 113b comprises a first major surface 115 and a second major surface 117 opposite the first major surface 115. In aspects, as shown, the first major surface 115 and/or the second major surface 117 can be planar (e.g., extend along a plane), and/or the first major surface 115 can be parallel to the second major surface 117. A substrate thickness 119 (for the substrate 113b) is defined as an average distance between the first major surface 115 and the second major surface 117. In aspects, the substrate thickness 119 for one or more substrates of the plurality of substrates 111 (e.g., all substrates of the plurality of substrates) can be about 10 μm or more, about 15 μm or more, about 20 μm or more, about 30 μm or more, about 40 μm or more, about 50 μm or more, about 60 μm or more, about 800 μm or less, about 600 μm or less, about 400 μm or less, about 200 μm or less, about 150 μm or less, about 100 μm or less, about 90 μm or less, about 80 μm or less, about 70 um or less, about 60 μm or less, about 50 μm or less, or about 40 μm or less. In aspects, the substrate thickness 119 for one or more substrates of the plurality of substrates 111 (e.g., all substrates of the plurality of substrates) can be in a range from about 10 μm to about 800 μm, from about 10 μm to about 600 μm, from about 15 μm to about 400 μm, from about 15 μm to about 200 um, from about 20 μm to about 150 μm, from about 20 μm to about 100 μm, from about 30 μm to about 90 μm, from about 30 μm to about 80 μm, from about 40 μm to about 70 μm, from about 40 μm to about 60 μm, or any range or subrange therebetween. In aspects, a number of substrates in the plurality of substrates 111 can be 3 or more, 5 or more, 10 or more, 15 or more, 100 or less, 50 or less, 30 or less, or about 25 or less, for example, from 3 to 100, from 5 to 50, from 10 to 30, from 15 to 25, or any range or subrange therebetween.

Throughout the disclosure, electrical conductivity is measured in accordance with ASTM E10004-17 at 20° C. In aspects, the substrate can be an electrical insulator. In aspects, an electrical conductivity of a substrate of the plurality of substrates 111 can be about 10 Siemens per meter (S/m) or less, about 0.1 S/m or less, about 10⁻³ S/m or less, about 10⁻⁵ S/m or less, about 10⁻⁶ S/m or less, about 10⁻⁷ S/m or less, about 10⁻¹⁵ S/m or more, about 10⁻¹² S/m or more, about 10⁻¹⁰ S/m or more, about 10⁻⁸ S/m or more. In aspects, an electrical conductivity of a substrate of the plurality of substrates 111 can be in a range from about 10 S/m to about 10⁻¹⁵ S/m, from about 0.1 S/m to about 10⁻¹⁵ S/m, from about 10⁻³ S/m to about 10⁻¹² S/m, from about 10⁻⁵ S/m to about 10⁻¹² S/m, from about 10⁻⁶ S/m to about 10⁻¹⁰ S/m, from about 10⁻⁷ S/m to about 10⁻⁸ S/m, or any range or subrange therebetween.

Throughout the disclosure, a dielectric loss tangent is measured in accordance with ASTM D3380-22 modified to measure the property at a frequency of 20 GigaHertz (GHz). In aspects, a dielectric loss tangent of a material of the substrate of the plurality of substrates 111 can be about 0.01 or less, about 0.001 or less, about 0.0005 or less, or about 0.0002 or less. In aspects, a dielectric loss tangent of a material of the substrate of the plurality of substrates 111 can be in a range from about 10⁻⁶ to about 0.01, from about 10⁻⁵ to about 0.001, from about 10⁻⁴ to about 0.0005, or any range or subrange therebetween.

In aspects, the substrate of the plurality of substrates 111 can be a glass-based material and/or a ceramic-based material. As used herein, “glass-based” includes both glasses and glass-ceramics, wherein glass-ceramics have one or more crystalline phases and an amorphous, residual glass phase. A glass-based material may comprise an amorphous material (e.g., glass) and optionally one or more crystalline materials (e.g., ceramic). Exemplary glass-based materials may be an alkali-free glass and/or comprise a low content of alkali metals (e.g., R₂O of about 10 mol % or less, wherein R₂O comprises Li₂O Na₂O, and K₂O). As used herein, “ceramic-based” includes both ceramics and glass-ceramics, wherein glass-ceramics have one or more crystalline phases and an amorphous, residual glass phase. In aspects, ceramic-based materials can comprise one or more oxides, nitrides, oxynitrides, carbides, borides, and/or silicides. In aspects, ceramic-based materials can comprise alumina, zirconia, steatite, quartz, or combinations thereof. In aspects, ceramic-based materials can consist essentially of crystal phases. Exemplary aspects of ceramic-based materials are alumina and zirconia. Throughout the disclosure, the Young's modulus of the glass-based materials and ceramic-based materials are measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, a substrate of the plurality of substrates 111 can comprise an elastic modulus ranging from about 10 GPa to about 300 GPa, from about 40 GPa to about 200 GPa, from about 60 GPa to about 100 GPa, from about 60 GPa to about 80 GPa, from about 80 GPa to about 100 GPa, or any range or subrange therebetween

As shown in FIGS. 1-2, one or more vias 135 can extend through a substrate (e.g., substrate 113a) of the plurality of substrates 111. In aspects, a dimension 139 of the one or more vias 135 (measured perpendicular to a direction of the substrate thickness) can be about 5 μm or more, about 10 μm or more, about 25 μm or more, about 40 μm or more, about 100 μm or more, about 1 millimeter (mm) or less, about 600 μm or less, about 300 μm or less, about 100 μm or less, about 60 μm or less, about 40 μm or less, or about 30 μm or less. In aspects, a dimension 139 of the one or more vias 135 (measured perpendicular to a direction of the substrate thickness) can be in a range from about 5 μm to about 1 mm, from about 10 μm to about 600 μm, from about 25 μm to about 300 μm, from about 25 μm to about 100 μm, from about 40 μm to about 60 μm, or any range or subrange therebetween. In aspects, as shown, one or more of the vias 135 can be aligned (in the direction of the substrate thickness) to form a through hole extending through the laminate 101 and 201. Alternatively or additionally, vias can be aligned extending through some but not all of the plurality of substrates to form a blind via and/or a buried via.

As shown in FIGS. 1-2, the plurality of metallic traces 121 can be electrically connected through the one or more vias 135 and/or be at least partially positioned in the one or more vias 135. In aspects, the plurality of metallic traces can extend through one or more vias 135 in at least one substrate (e.g., substrates 113a and 113b). In aspects, the plurality of metallic traces 121 can be disposed between adjacent pairs of substrates (e.g., metallic trace 123b positioned between adjacent pair of substrates 113a and 113b and metallic trace 123c positioned between adjacent pair of substrates 113b and 113c). With reference to metallic trace 123b, the metallic trace 123b is disposed on a substrate 113a, and another substrate 113b is disposed on the metallic trace 123b such that the metallic trace 123b is positioned between (sandwiched between) substrates 113a and 113b. Further, another metallic trace 123c is disposed on the substrate 113b and the metallic traces 123b and 123c are electrically connected through the one or more vias 135 by material of the plurality of metallic traces 121 positioned therein. For example, with reference to FIGS. 1-2, a first metallic trace 124 is electrically connected to a second metallic trace 126 (where the second metallic trace is disposed on a second substrate—substrate 113b—that is, in turn, disposed on the first metallic trace 124) by metallic material 136 (associated with the plurality of metallic traces 121) position in a via of the one or more vias 135.

A metallic material of the plurality of metallic traces 121 can be electrically conductive. In aspects, an electrical conductivity of the plurality of metallic traces 121 can be about 10⁵ S/m or more, 10⁶ S/m or more, about 5×10⁶ S/m or more, about 10⁷ S/m or more, about 5×10⁷ S/m or more, about 10¹² S/m or less, about 10¹⁰ S/m or less, about 10⁹ S/m or less, about 10⁸ S/m or less, or about 10⁷ S/m or less. In aspects, an electrical conductivity of a material of the plurality of metallic traces 121 can be in a range from about 10⁵ S/m to about 10¹² S/m, from about 10⁶ S/m to about 10¹⁰ S/m, from about 5×10⁶ S/m to about 10⁹ S/m, from about 10⁷ S/m to about 10⁹ S/m, from about 5×10⁷ S/m to about 10⁸ S/m, or any range or subrange therebetween. In aspects, the metallic material of the plurality of metallic traces can comprise, consist essentially of, or consist of the metallic material of the plurality of metallic traces comprises copper, silver, gold, aluminum, nickel, platinum, or alloys with or without conductive carbon or combinations thereof.

Throughout the disclosure, a grain size of the plurality of metallic traces is determined in accordance with ASTM E112-13. As such, a scanning electron microscope (SEM) image is taken of a cross-section. For determining the grain size distribution (e.g., minimum, maximum, mean), the SEM images were taken at 20,000 times magnification and at least 20% of the area in the SEM image is analyzed to determine the grain size distribution. From the calculated grain sizes, values such as the average (e.g., mean), maximum, and minimum values of the resulting distribution of grain sizes can be calculated. In aspects, an average (e.g., mean) grain size of the plurality of metallic traces can be about 10 nanometers (nm) or more, about 20 nm or more, about 50 nm or more, about 80 nm or more, about 100 nm or more, about 150 nm or more, about 200 nm or more, about 250 nm or more, about 300 nm or more, about 350 nm or more, about 400 nm or more, about 800 nm or less, about 700 nm or less, about 600 nm or less, about 550 nm or less, about 500 nm or less, about 450 nm or less, about 400 nm or less, about 350 nm or less, about 300 nm or less, about 250 nm or less, or about 200 nm or less. In aspects, an average (e.g., mean) grain size of the plurality of metallic traces can be in a range from about 10 nm to about 800 nm, from about 20 nm to about 700 nm, from about 50 nm to about 600 nm, from about 80 nm to about 550 nm, from about 100 nm to about 500 nm, from about 150 nm to about 450 nm, from about 200 nm to about 400 nm, from about 250 nm to about 350 nm, from about 250 nm to about 300 nm, or any range or subrange therebetween. In preferred aspects, the average (e.g., mean) grain size of the plurality of metallic traces can be from about 10 nm to about 800 nm or from about 100 nm to about 500 nm. In aspects, a minimum grain size of the plurality of metallic traces can be within one or more of the ranges discussed above in this paragraph for the average grain size. In aspects, a maximum grain size of the plurality of metallic traces can be within one or more of the ranges discussed above in this paragraph for the average grain size. As discussed below, an average grain size within one or more of the above-mentioned ranges in this paragraph can be formed by metallic organic deposition of the plurality of metallic traces, for example, using aerosol jet deposition, although other methods can be used in other aspects to deposit a conductive ink to form the plurality of metallic traces.

As shown in FIGS. 1-2, metallic trace 123b of the plurality of metallic traces 121 comprises a third major surface 125 and a fourth major surface 127 opposite the third major surface 125. As shown, the first major surface 115 of the substrate 113b can contact the fourth major surface 127 of the metallic trace 123b. Likewise, the third major surface 125 of the metallic trace 123b can contact the substrate 113a. A metallic thickness 129 (for the metallic trace 123b) is defined as an average distance between the third major surface 125 and the fourth major surface 127. In aspects, the metallic thickness 129 for one or more metallic traces of the plurality of metallic traces 121 (e.g., all metallic traces of the plurality of metallic traces) can be about 5 μm or more, 10 μm or more, about 15 μm or more, about 20 μm or more, about 30 μm or more, about 40 μm or more, about 50 μm or more, about 500 μm or less, about 250 μm or less, about 150 μm or less, about 100 μm or less, about 80 μm or less, about 60 μm or less, or about 40 μm or less. In aspects, the metallic thickness 129 for one or more metallic traces of the plurality of metallic traces 121 (e.g., all metallic traces of the plurality of metallic traces) can be in a range from about 5 μm to about 500 μm, from about 10 μm to about 250 μm, from about 15 μm to about 150 μm, from about 20 μm to about 100 μm, from about 30 μm to about 80 μm, from about 40 μm to about 60 μm, or any range or subrange therebetween. In aspects, the metallic thickness 129 can be in a range from about 5 μm to about 60 μm, from about 5 μm to about 40 μm, from about 10 μm to about 20 μm, or any range or subrange therebetween.

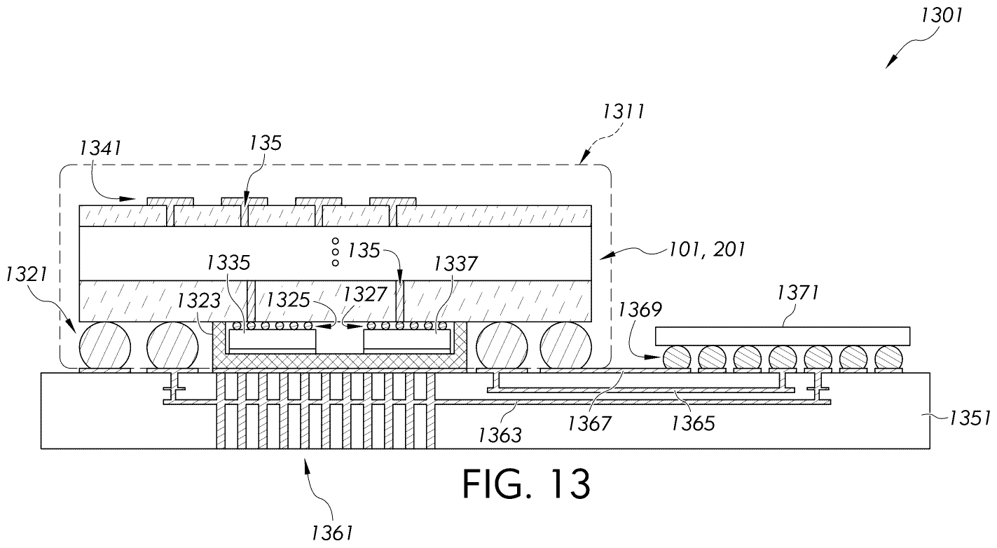

Taken together, as shown in FIGS. 1-2, the plurality of metallic traces 121 can provide an electrical connection between the extreme ends of the plurality of metallic traces 121 (metallic traces 123a and 123h), for example, from one end of the laminate 101 or 201 (e.g., second major surface 107) to an opposite end of the laminate (e.g., first major surface 105) and/or an external electrical device (see FIG. 13). In addition to providing an electrical connection through the laminate 101 or 201, one or more metallic traces can function to bond adjacent pairs of substrates together (e.g., metallic trace 123b bonding the substrates 113a and 113b together). In aspects, adjacent pairs of substrate can be bonded together by at least a metallic trace positioned therebetween (e.g., metallic trace 123b bonding the substrates 113a and 113b together).

In aspects, one or more metallic traces of the plurality of metallic traces can be configured to function as a ground, an antenna, or other function as part of the laminate. For example, FIGS. 1-2 and 13 show an antenna 141 or 1341 formed from a metallic trace (e.g., metallic trace 123h) of the plurality of metallic trace, although a metallic trace can be configured to couple and/or electrically connect the laminate to an antenna (external to the laminate). As used herein, “antenna-in-packaging” refers to a laminate comprising a plurality of substrates incorporating an antenna formed from a metallic trace of the plurality of metallic traces, as shown in FIGS. 1-2 and 13. For example, the antenna 141 or 1341 can be configured to receive and/or transmit signals comprising a frequency in the millimeter wave (mmWave) band and/or sub-TeraHertz (sub-THz) band. In further aspects, the antenna 141 or 1341 can be configured to receive and/or transmit signals comprising a frequency of about 20 GigaHertz (GHz) or more, about 25 GHz or more, about 30 GHz or more, about 35 GHz or more, about 50 GHz or more, about 90 GHz or more, about 100 GHz or more, about 120 GHz or more, about 140 GHz or more, about 170 GHz or more, about 200 GHz or more, about 230 GHz or more, about 260 GHz or more, about 400 GHz or less, about 300 GHz or less, about 240 GHz or less, about 200 GHz or less, about 150 GHz or less, about 130 GHz or less, about 100 GHz or less, about 80 GHz or less, about 60 GHz or less, about 40 GHz or less, or about 30 GHz or less. In further aspects, the antenna 141 or 1341 can be configured to receive and/or transmit signals comprising a frequency in a range from about 20 GHz to about 400 GHz, from about 25 GHz to about 300 GHz, from about 30 GHz to about 240 GHz, from about 35 GHz to about 200 GHz, from about 50 GHz to about 150 GHz, from about 90 GHz to about 130 GHz, from about 100 GHz to about 120 GHz, or any range or subrange therebetween. For example, the antenna 141 or 1341 can be configured to receive and/or transmit signals comprising a frequency in a band from about 25 GHz to about 30 GHz, from about 35 GHz to about 40 GHz, or from about 120 GHz to about 150 GHz. Additionally, or alternatively, an interior metallic trace of the plurality of metallic traces (e.g., metallic trace 123d) can function as a ground 131, for example, an electrical and/or magnetic ground plane to isolate the antenna from electrical components (e.g., an integrated circuit) on the other side of the ground while the plurality of metallic traces is also configured to transmit signals therebetween (e.g., between an integrated circuit and the antenna). Providing an antenna-in-packaging design can facilitate assembly (e.g., reducing the number of components that need to be precisely aligned in final assembly of a consumer electronic device) and/or facilitate miniaturization of the electronic components (including increasing an operating frequency to within one or more of the above-mentioned bands)

In aspects, as shown in FIG. 1, the laminate 101 can consist essentially of and/or consist of the plurality of metallic traces 121 and the plurality of substrates 111. Alternatively, as shown in FIG. 2, the laminate 201 can further comprise one or more dielectric layers (e.g., a plurality of dielectric layers 251—dielectric layers 253a-253h). As shown in FIG. 2, a dielectric layer (e.g., dielectric layer 253 can be positioned between an adjacent pair of substrates (e.g., substrates 113a and 113b) of the plurality of substrates 111. The dielectric layer 253 can comprise a fifth major surface 255 and a sixth major surface 257 opposite the fifth major surface 255. As shown, the first major surface 115 of the substrate 113b can contact the sixth major surface 257 of the dielectric layer 253b. Likewise, the fifth major surface 255 of the dielectric layer 253b can contact the substrate 113a. A dielectric thickness defined as an average distance between the fifth major surface 255 and the sixth major surface 257 can be within one or more of the ranges discussed above for the metallic thickness. In further aspects, the dielectric thickness can be substantially equal to the metallic thickness 129 of corresponding the metallic trace positioned between the same adjacent pair of substrates.

In aspects, as shown in FIG. 2, a dielectric layer 253b or 254 can contact the metallic trace 124 or 123b at location 244. In aspects, as shown, a dielectric layer 253b can be positioned at a peripheral location between the adjacent pair of substrates 113a and 113b, for example, with at least a portion of the dielectric layer 254 peripherally located relative to at least a portion of the corresponding metallic trace. Providing the dielectric layer can enable improved environmental resistance (e.g., moisture resistance and/or chemical resistance) to the metallic traces.

In aspects, an electrical conductivity at 20° C. of one or more dielectric layers of the plurality of dielectric layers 251 can be within one or more of the corresponding ranges discussed above for the electrical conductivity of the substrate (e.g., about 0.1 S/m or less, from about 10⁻³ S/m to about 10⁻¹² S/m, or from about 10⁻⁶ S/m to about 10⁻¹⁰ S/m). In aspects, a dielectric loss tangent at 20 GHz and at 20° C. can be within one or more of the corresponding ranges discussed above for the dielectric loss tangent of the substrate (e.g., about 0.01 or less, from about 10⁻⁵ to about 0.001, or from about 10⁻⁴ to about 0.0005). In aspects, the dielectric material can be moisture-resistant and/or have chemical resistance. In aspects, a dielectric material of one or more of the plurality of dielectric layers can be an adhesive (e.g., pressure-sensitive adhesive). In further aspects, adjacent pairs of substrates of the plurality of substrates can be bonded together by both a metallic trace and a dielectric layer positioned therebetween.

Aspects of the disclosure can comprise a consumer electronic product. The consumer electronic product can comprise a front surface, a back surface, and a side surface. The consumer electronic product can further comprise electrical components at least partially within the housing. The electrical components can comprise a controller, a memory, and a display. The display can be at or adjacent to the front surface of the housing. The display can comprise a liquid crystal display (LCD), an electrophoretic display (EPD), an organic light-emitting diode (OLED) display, or a plasma display panel (PDP). The consumer electronic product can comprise a cover substrate disposed over the display. In aspects, at least one of the electrical components or the housing includes the laminate discussed throughout the disclosure. The consumer electronic product can comprise a portable electronic device, for example, a smartphone, a tablet, a wearable device, or a laptop.

For example, the laminate 101 or 102 can be antenna-in-packaging 1311 as part of an electronic device 1301 (e.g., telecommunications device). The antenna 1341 of the antenna-in-packaging 1311 is in electrical communication with power amplifier 1335 and a radio-frequency integrated circuit (RFIC) in an RF shielding container 1323 by metallic material positioned in the one or more vias 135, the plurality of metallic traces (see FIGS. 1-2), and connections 1325 and 1327, respectively. Similarly, signals can be transmitted from the antenna 1341, the power amplifier 1335, and/or the RFIC 1337 to a digital integrated circuit 1371 (or vice versa) through various electrical traces 1363, 1365, and 1367 in a circuit board 1351 (e.g., printed circuit board) and connections 1321 and/or 1369 to the digital integrated circuit 1371.

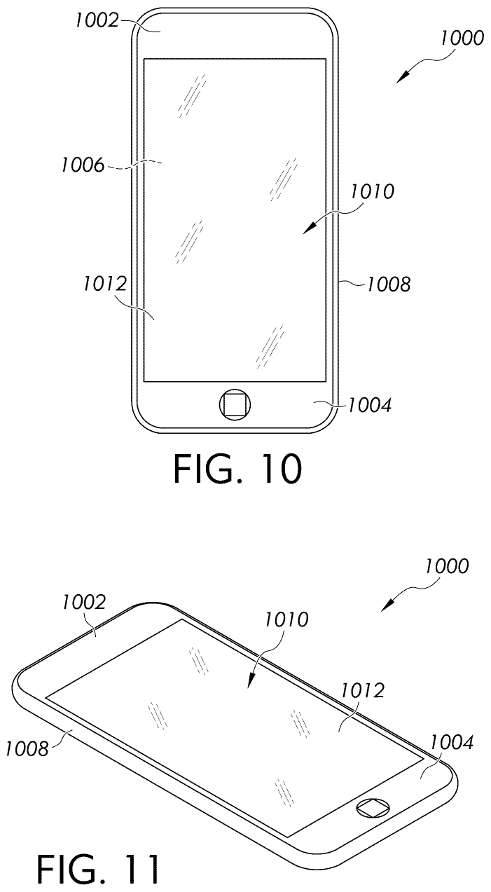

The laminate disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from incorporating communication elements (e.g., antenna or antenna-in-packaging). An exemplary article incorporating any of the foldable apparatus disclosed herein is shown in FIGS. 10-11. Specifically, FIGS. 10-11 show a consumer electronic device 1000 including a housing 1002 having front 1004, back 1006, and a side surface 1008. Although not shown, the consumer electronic device can comprise electrical components that are at least partially inside or entirely within the housing. For example, electrical components include at least a controller, a memory, and a display. As shown in FIGS. 10-11, the display 1010 can be at or adjacent to the front surface of the housing 1002. The consumer electronic device can comprise a cover substrate 1012 at or over the front surface of the housing 1002 such that it is over the display 1010. In aspects, at least one of the electrical components or the housing 1002 includes the laminate discussed throughout the disclosure, for example, as antenna-in-packaging.

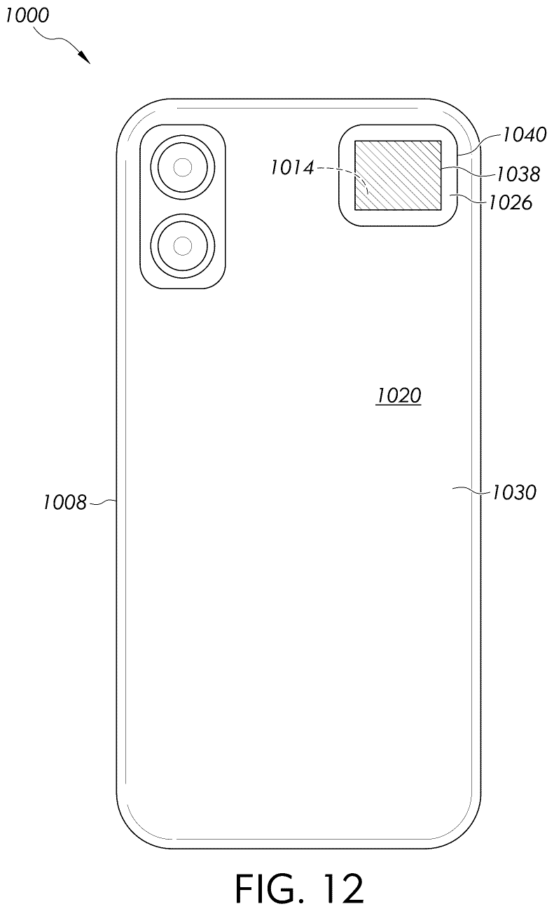

Further, referring to FIG. 12, a consumer electronic device 1000 (e.g., communicating device, for example with wireless signal communication capability such as a broadband communicating device, cellular phone, smartphone, control panel, console, dashboard, tablet, handheld computer, electronic tool) includes laminate 1014. In aspects, the laminate 1014 includes a laminate 1014, for example, as antenna-in-packaging. The laminate 1014 can be in electrical communication with other components, for example an integrated circuit, an RF generator, a power amplifier, printed circuit board, a processor, a memory, a battery, a connector port, and other components and/or combinations thereof. The laminate can be configured to function as a transceiver, receiver, transmitter, antenna array, or communication module (e.g., configured to transmit and/or receive communication signals at or over a frequency range). A surface area of the laminate 1014 is defined as an area within a perimeter 1038 surrounding the laminate 1014 (e.g., antenna or antenna-in-packaging). In further aspects, the surface area of the laminate can be 25 cm² or less, 15 cm² or less, 10 cm² or less, 100 μm² or more, 1 mm² or more, 25 mm² or more, or 100 mm² or more. In further aspects, the laminate 1014 can be configured for wireless communication (e.g., transmitting, receiving, operating, and/or otherwise communicating) with transmission of signals at a frequency of 100 MHz or more, 1 GHz or more, 10 GHz or more, 24 GHz or more, 24.25 GHz or more, GHz or more, 26 GHz or more, 28 GHz or more, 100 GHz or less, 60 GHz or less, 50 GHz or less, 47 GHz or less, or 40 GHz or less. For example, the laminate 1014 may operate in a frequency range from 26 GHz to 40 GHz or from 60 GHz to 80 GHz. Communication at a frequency greater than 26 GHz may be particularly benefited from the present disclosure because such signals may be more inhibited by transmission through solid materials, and may accordingly be improved greatly by using a housing (e.g., back cover 1030 having back surface 1020) incorporating a structure 1026 with reduced thickness in a region configured to accommodate the laminate 1014. As such, the laminate 1014 can be positioned and/or oriented such that signals are transmitted through the structure 1026 (e.g., directly facing the structure 1026, the structure 1026 may overlay at least a portion of the laminate 1014). In further aspects, a minimum distance between the laminate 1014 to a portion of the glass article defining the structure 1026 can be 5 mm or less, 3 mm or less, 2 mm or less, or 0.6 mm or less. Alternatively, the laminate 1014 and the portion of the glass article defining the structure 1026 may be in direct contact or separated only by a thickness of a coating that can be positioned therebetween. Also, the structure 1026 can be defined by a perimeter 1040, which can demarcate a thickness difference between the structure 1026 and the other portions of the back cover 1030, for example, by 50 μm or more, by 100 μm or more, by 150 μm or more, by 200 μm or more, by 300 μm or more, by 500 μm or more.

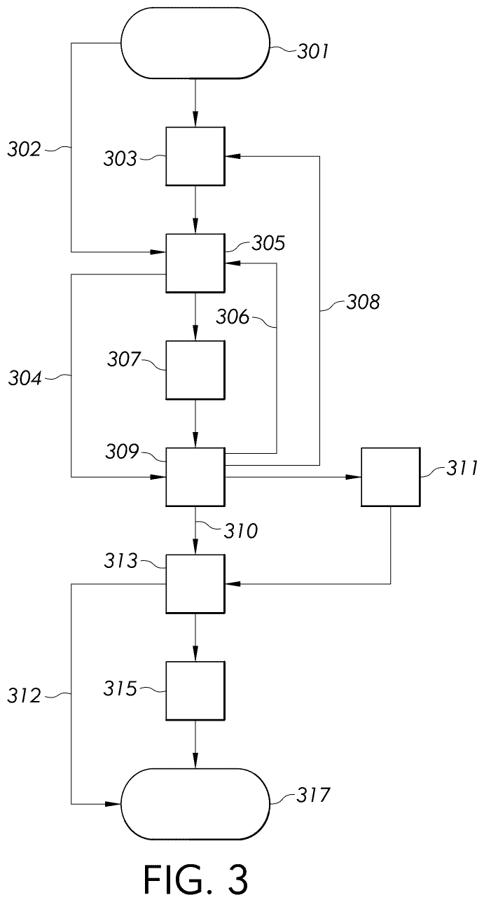

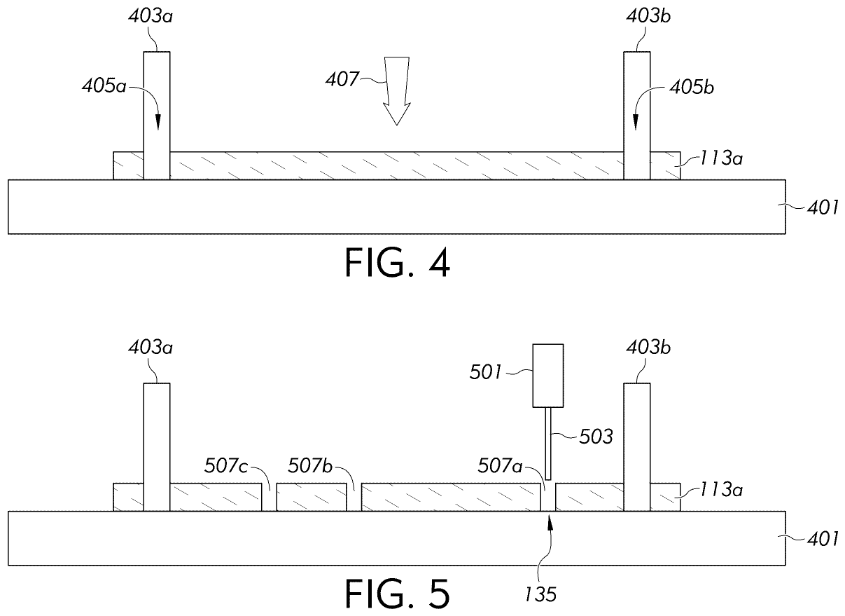

Aspects of methods of making a laminate (e.g., antenna-in-packaging) in accordance with the aspects of the present disclosure will now be discussed with reference to the flow chart shown in FIG. 3 and example method steps illustrated in FIGS. 4-9.

In a first step 301, as shown in FIGS. 4-5, methods can start with obtaining a first substrate 113a (or a plurality substrates). In aspects, the first substrate 113a may be provided by purchase or otherwise obtaining a substrate or by forming the substrate. In aspects, the first substrate 113a can comprise a glass-based substrate and/or a ceramic-based substrate. In further aspects, glass-based substrates and/or ceramic-based substrates can be provided by forming them with a variety of ribbon forming processes, for example, slot draw, down-draw, fusion down-draw, up-draw, press roll, redraw, or float. In further aspects, ceramic-based substrates can be provided by heating a glass-based substrate to crystallize one or more ceramic crystals. In aspects, the substrate and/or the plurality of substrates can comprise alumina, zirconia, steatite, quartz, or a glass-based material. In aspects, the substrate and/or the plurality of substrates can comprise an electrical conductivity (at 20° C.) within one or more of the corresponding ranges discussed above for the plurality of substrates (e.g., about 10 S/m or less or about 10⁻⁶ S/m or less). In aspects, the substrate and/or the plurality of substrates can comprise a dielectric loss tangent at 20° C. and 20 GHz within one or more of the corresponding ranges discussed above for the plurality of substrates (e.g., about 0.01 or less). In aspects, a thickness of the substrate can be within one or more of the corresponding ranges discussed above for the substrate thickness (e.g., from about 10 μm to about 800 μm or from about 20 μm to about 100 μm). In aspects, as shown, the first substrate 113a (or the plurality of substrates) can have a plurality of holes (holes 405a and 405b) therethrough configured to be aligned with a corresponding plurality of alignment pins (e.g., alignment pins 403a and 403b) in an alignment jig 401. In further aspects, a first substrate 113a can be disposed on the alignment jig 401 (as indicated by arrow 407) with the plurality of alignment pins (alignment pins 403a and 403b) extending through the corresponding plurality of holes (holes 405a and 405b) in the first substrate 113a. In aspects, although not shown, a metallic trace can be disposed on the first substrate 113a by the end of step 301 (e.g., see metallic trace 123a in FIGS. 1-2, where the first substrate 113a can then be flipped so that the metallic trace faces the alignment jig to enable subsequent deposition of another metallic trace 123b). In aspects, as shown in FIG. 5, by the end of step 301, the first substrate 113a (or the plurality of substrates) can comprise one or more vias 135 or 507a-507c extending through the first substrate 113a (or the plurality of substrates). Alternatively, as discussed below, the one or more vias 135 or 507a-507c can be formed in a substrate (e.g., first substrate 113a) in step 303.

In aspects, after step 301, as shown in FIG. 4-5, methods can proceed to step 303 comprising disposing a substrate on the alignment jig. As discussed above, with reference to FIG. 4, the first substrate 113a can be disposed on the alignment jig 401 (as indicated by arrow 407) with the plurality of alignment pins (alignment pins 403a and 403b) extending through the corresponding plurality of holes (holes 405a and 405b) in the first substrate 113a. In further aspects, step 303 can further comprise forming one or more vias 135 (e.g., vias 507a-507c) in the substrate (e.g., the first substrate 113a). In even further aspects, as shown in FIG. 5, forming the one or more vias 135 or 507a-507c can comprise laser drilling the one or more vias 507a-507c, although other methods of forming the one or more vias can be used in further aspects. For example, laser drilling can comprise emitting a laser beam 503 from a laser 501, where the laser beam impinges a predetermined location on the first substrate 113a and forms a via 507a. Further, a relative movement between the laser 501 and the substrate 113a can be used to align a subsequent laser beam 503 with another predetermined location on the first substrate to form a plurality of holes that can be repeated to form one or more vias 507a-507c, although other methods can be used to move the laser beam 503 to predetermined locations on the substrate in other aspects, for example, using a mirror. Alternatively, the one or more vias in the substrate may already be formed in the substrate before step 303. Also, the one or more vias in the plurality of substrate can be formed in the substrate (e.g., present in the substrate) before step 303. Alternatively, vias can be formed in step 301 or 303 (e.g., the first instance of step 303), for example, by processing each substrate on the alignment jig to form the corresponding one or vias before disposing another substrate thereon and repeating the process, where the plurality of substrates are removed from the alignment jig before the first substrate 113a is disposed on the alignment jig 401 (again) as shown in FIG. 4 but with the plurality of vias 507a-507c already formed therein. Additionally, in aspects, other methods (e.g., mechanical drilling, etching) of forming the corresponding one or more vias can be used instead of or in addition to laser drilling when the corresponding one or more vias is formed in the plurality of substrates before disposing any metallic traces.

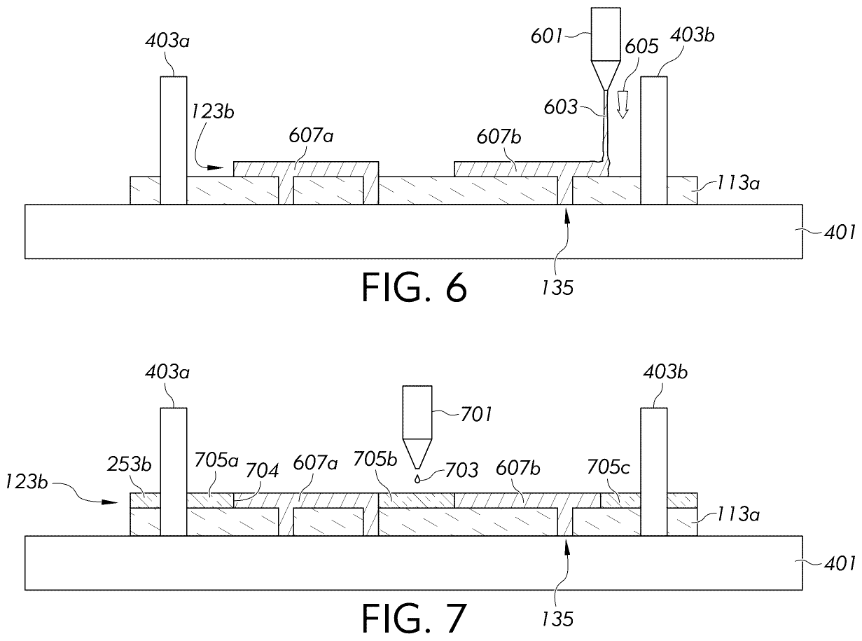

In aspects, after step 301 or 303, as shown in FIG. 6, methods can proceed to step 305 comprising disposing a metallic trace (e.g., metallic trace 123b) on the substrate (e.g., first substrate 113a) and in the one or more vias 135 therein. In further aspects, a precursor material 603 can be dispensed from a container 601 (e.g., conduit, flexible tube, micropipette, ink-jet print head, or syringe) as indicated by arrow 605 over and/or on the substrate (e.g., first substrate 113a) to form the metallic trace 123b (e.g., portions 607a-607b). In even further aspects, the precursor material 603 can be a conductive ink (e.g., electrically conductive ink). In even further aspects, disposing the precursor material 603 to form a portion 607a or 607b of the metallic trace 123b can comprise ink-jet printing (e.g., ink-jet printing an electrically conductive ink), brushing, aerosol jet printing, or combinations thereof. An exemplary aspects of disposing the precursor material (e.g., forming a portion of the metallic trace) is aerosol jet printing. For example, as shown, aerosol jet printing can comprise a carrier gas (e.g., inter gas such as nitrogen) propelling the precursor material 603 (as an aerosol in the carrier gas) towards the first substrate 113a as indicated by arrow 605. Alternatively or additionally, disposing the metallic trace (or a portion thereof) can comprise metal organic decomposition. For example, the precursor can comprise a metal-organic compound that decomposes (e.g., or otherwise reacts and/or upon deposition) to form an electrically conductive, metallic trace (e.g., conductive ink). In aspects, a metal of the metal-organic compound can comprise copper, silver, gold, aluminum, nickel, platinum, or alloys with or without conductive carbon or combinations thereof. In aspects, an organic group of the metal-organic compound can be an acetate, a tert-butyl group, a trimethyl group, a triethyl group, an isopropyl group, or combinations thereof (e.g., diethyl-methyl). In aspects, a temperature of an environment and/or the substrate (e.g., first substrate 113a) when the precursor material 603 (e.g., metal-organic compound) is disposed thereon can be about 60° C. or more, about 65° C. or more, about 70° C. or more, about 75° C. or more, about 80° C. or more, about 350° C. or less, about 300° C. or less, about 250° C. or less, about 200° C. or less, about 150° C. or less, about 100° C. or less, about 90° C. or less, or about 80° C. or less. In aspects, a temperature of an environment and/or the substrate (e.g., first substrate 113a) when the precursor material 603 (e.g., metal-organic compound) is disposed thereon can be in a range from about 60° C. to about 350° C., from about 65° C. to about 300° C., from about 70° C. to about 300° C., from about 70° C. to about 250° C., from about 75° C. to about 200° C., from about 75° C. to about 150° C., from about 75° C. to about 100° C., from about 75° C. to about 90° C., from about 80° C. to about 90° C., or any range or subrange therebetween. Providing a temperature within one or more of the ranges mentioned above in this paragraph can facilitate the formation of the metallic trace (e.g., decomposition of the metal-organic precursor) and/or enhance an electrical conductivity of the resulting metallic trace.

In aspects, an electric conductivity of the metallic trace 123b (or a portion thereof 607a-607b) can be within one or more of the corresponding ranges discussed above for the electric conductivity of the plurality of metallic traces (e.g., about 10⁵ S/m or from about 5×10⁶ S/m to about 10⁹ S/m). In aspects, a median grain size of a portion of the metallic trace can be within one or more of the corresponding ranges discussed above for the plurality of metallic traces (e.g., from about 10 nm to about 800 nm or from about 100 nm to about 500 nm).

In aspects, after step 305, as shown in FIG. 7, methods can proceed to step 307 comprising disposing a dielectric layer 253b (e.g., portions 705a-705c) on the substrate (e.g., first substrate 113a). In aspects, as shown, the dielectric layer 253b (e.g., portion 705b) can be adjacent to and/or contact a portion of the metallic trace (e.g., portion 607a and/or 607b of metallic trace 123b). Additionally or alternatively, as shown, a portion 705a or 705c of the dielectric layer 253b can be positioned at a peripheral location and disposed on the substrate (e.g., first substrate 113a) with at least a portion 607a-607b (or all) of the metallic trace 123b positioned more centrally than the dielectric material (relative to a position on the substrate-first substrate 113a). In aspects, as shown, disposing the dielectric layer 253b (e.g., portions 705a-705c) on the substrate (e.g., first substrate 113a) can comprise dispensing a precursor material 703 from a container 701 (e.g., conduit, flexible tube, micropipette, ink-jet print head, or syringe). In aspects, the dielectric material can comprise any of the corresponding materials discussed above for the dielectric material (e.g., adhesive). In aspects, the dielectric material can comprise an electrical conductivity (at 20° C.) can be within one or more of the corresponding ranges discussed above for the electrical conductivity of the dielectric material (e.g., about 0.1 S/m or less or from about 10⁻⁶ S/m to about 10⁻¹⁰ S/m). In aspects, a dielectric loss tangent (at 20° C. and 20 GHZ) of the dielectric material can be within one or more of the corresponding ranges discussed above (e.g., about 0.01 or less, from about 10⁻⁵ to 0.001).

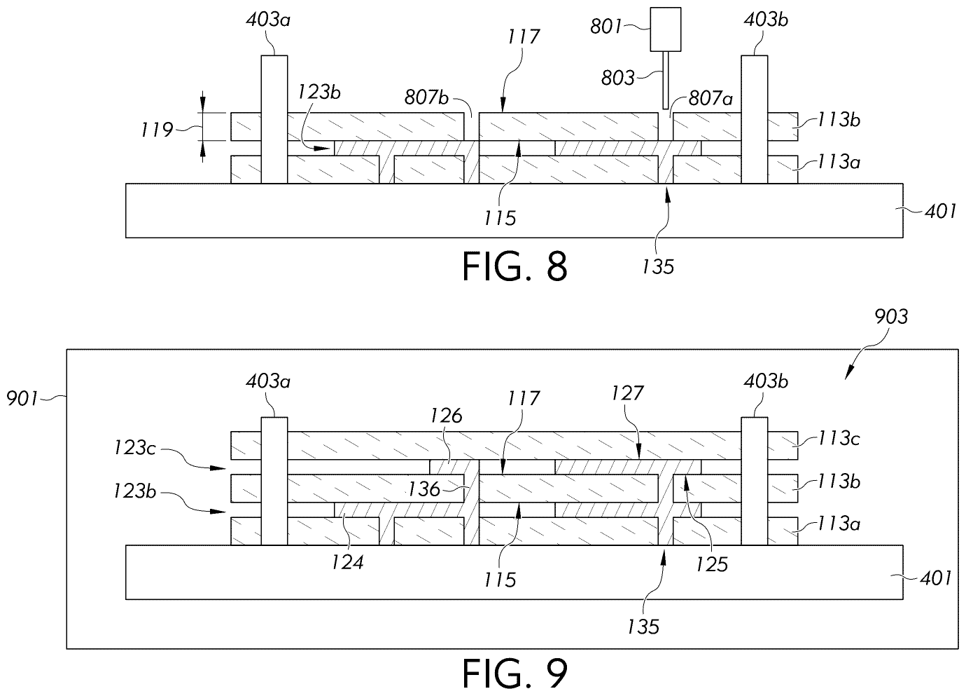

In aspects, after step 305 or 307, as shown in FIG. 8, methods can proceed to step 309 comprising disposing another substrate (e.g., second substrate 113b) over the first substrate 113a. In further aspects, as shown, the another substrate (e.g., second substrate 113b) can be disposed on the metallic trace 123b and/or the dielectric layer 253b. In aspects, the metallic trace 123b can contact both the first substrate 113a and the second substrate 113b. In further aspects, as shown, the second substrate can be positioned such that the alignment pins 403a and 403b extend through corresponding holes in the second substrate 113b. In further aspects, as shown, one or more vias can be formed in the substrate 113b, which can comprise any of the methods for forming the vias discussed above with reference to step 303. For example, vias 807a and 807b can be formed by impinging predetermined locations of the second major surface 117 (opposite the first major surface 115) with a laser beam 803 emitted from a laser 801. Alternatively, when the method comprises following arrow 306 or 308 from step 309 to step 305 or 303 to add another substrate and metallic trace, the combination of temporally adjacent steps 309 and 303 can comprise disposing a single additional substrate.

With reference to FIG. 9, methods can repeat steps 303, 305, 307, and/or 309 a predetermined number of times to create a laminate with a predetermined number of metallic traces positioned between a similarly predetermined number of substrates (e.g., the plurality of substrates). Although not shown in FIG. 9 (see FIGS. 2 and 7), it is to be understood that dielectric material can optionally be positioned between pairs of adjacent substrates (through step 307). In aspects, as shown, a metallic trace 123c can be disposed on the second substrate 113b and in (e.g., within) the one or more vias (e.g., via 136) through the second substrate (and/or contact the metallic trace 123b). Consequently, metallic material associated with the plurality of metallic traces 123b-123c can extend from a first metallic trace 124 (e.g., metallic trace 123b) through metallic material 136 positioned in via 135 to a second metallic trace 126 (e.g., metallic trace 123c). Further, as shown in FIG. 9, another substrate 113c can be disposed over the substrates 113a and 113c and/or disposed over the metallic trace 123c. In further aspects, the substrate 113c can be further processed to form vias that can be filled with metallic material in a subsequent loop through steps 303, 305, 307, and/or 309 (e.g., following arrow 306 or 308). Alternatively or additionally, an uppermost substrate (e.g., substrate 113c) can be disposed on the underlying metallic trace (e.g., metallic trace 123c) to protect material of the metallic trace from environmental exposure and/or damage (and/or in conjunction with the use of an optional dielectric material-see FIGS. 2 and 7).

In aspects, after step 309, methods can further comprise disposing an uppermost metallic trace (e.g., metallic trace 123h and/or antenna 141 in FIGS. 1-2) on the substrate and in via formed therein. In further aspects, the metallic trace can be configured to act as an antenna (e.g., configures to transmit and/or receive signals at a frequency within one or more of the corresponding ranges discussed above).

In aspects, after step 309 or 311, as shown in FIG. 9, methods can proceed to step 313 heating an assembly 903 (of the plurality of substrates and the plurality of metallic traces) to form the laminate. In further aspects, as shown, step 313 can comprise placing the assembly 903 in an oven 901 maintained at a second temperature for a second predetermined period of time. Alternatively, heating the assembly can comprise translating the assembly through a furnace (or plurality of furnaces) to achieve a predetermined heating profile and/or associated heating time (e.g., second period of time). The heating in step 313 can form electrical connections between with plurality of metallic traces. Additionally, the heating in step 313 can bond adjacent pairs of substrates together at least in part by the metallic trace positioned therebetween (e.g., metallic trace 123b at least partially bonding the adjacent pair of substrates 113a and 113b together). In aspects, the second temperature can be about 150° C. or more, about 180° C. or more, about 200° C. or more, about 220° C. or more, about 250° C. or more, about 250° C. or more, about 300° C. or more, about 400° C. or more, about 500° C. or more, about 600° C. or more, about 750° C. or less, about 700° C. or less, about 650° C. or less, about 600° C. or less, about 500° C. or less, about 400° C. or less, about 350° C. or less, about 300° C. or less, about 250° C. or less, or about 200° C. or less. In aspects, the second temperature can be in a range from about 150° C. to about 750° C., from about 180° C. to about 700° C., from about 200° C. to about 650° C., from about 220° C. to about 600° C., from about 250° C. to about 500° C., from about 300° C. to about 400° C., from about 300° C. to about 350° C., or any range or subrange therebetween. In aspects, the second temperature can be about 500° C. or more, for example, from about 500° C. to about 750° C., from about 550° C. to abut 700° C., from about 600° C. to about 650° C., or any range or subrange therebetween. In aspects, the second temperature can be about 350° C. or less, for example, in a range from about 150° C. to about 350° C., from about 180° C. to about 300° C., from about 200° C. to about 250° C., or any range or subrange therebetween. Throughout the disclosure, heating “at” a specified temperature means that the heating provided from the local environment (e.g., heaters, oven) are maintained to provide a local temperature at the specified temperature. In aspects, the second period of time can be about 10 minutes or more, about 20 minutes or more, about 30 minutes or more, about 45 minutes or more, about 1 hour or more, about 1.5 hours or more, about 3 hours or less, about 2 hours or less, about 1.5 hours or less, about 1.0 hour or less, or about 0.75 hours or less. In aspects, the second period of time can be in a range from about 10 minutes to about 3 hours, from about 20 minutes to about 2 hours, from about 30 minutes to about 1.5 hours, from about 45 minutes to about 1.0 hour, or any range or subrange therebetween.

In aspects after step 313, as shown in FIGS. 12-13, methods can proceed to step 315 comprising assembling an electronic device (e.g., consumer electronic device) incorporating the laminate 101 or 201. After step 313 or 315, methods can be complete upon reaching step 317. In aspects, methods of making the making the laminate, antenna-in-packaging, and/or consumer electronic device in accordance with aspects of the disclosure can proceed along steps 301, 303, 305, 307, 309, 311, and 313 of the flow chart in FIG. 3 sequentially, as discussed above. In aspects, methods can follow arrow 302 from step 301 to step 305, for example, if a substrate comprising one or more vias is already present and ready for the metallic trace to be disposed thereon at the end of step 301. In aspects, methods can follow arrow 304 from step 305 to step 309, for example, if the laminate does not include dielectric material between an adjacent pair of substrates. In aspects, methods can follow arrow 306 from step 309 to step 305, for example, if another layer of metallic traces and substrates is to be disposed as part of making the laminate. In aspects, methods can follow arrow 308 from step 309 to step 303, for example, if another layer of metallic traces and substrates is to be disposed as part of making the laminate. In aspects, method can follow arrow 310 from step 311 to step 313, for example, if the laminate is not to have an outermost metallic layer (e.g., exposed antenna layer). In aspects, methods can follow arrow 312 from step 313 to step 317, for example if methods are complete at the end of step 313. Any of the above options may be combined to make laminate, antenna-in-packaging, and/or consumer electronic device in accordance with aspects of the disclosure.

The present disclosure provides laminates, antenna-in-packaging, and method of making the same. Laminates include a metallic trace (of a plurality of metallic traces) at least partially bonded together an adjacent pair of substrates (of a plurality of substrates). Having the metallic trace (at least partially) bond the laminate together while simultaneously providing electrical communication through the laminate can simplify manufacturing and/or reduce material costs associated with the laminate. Laminates can provide good electrical conductivity (through the plurality of metallic traces) between an antenna (that can be part of the laminate) and additional electronic components, which can be used for communication in the millimeter wave (mm Wave), 5G, 6G, and/or sub-TeraHertz (sub-THz) band(s) with low losses (e.g., low dielectric loss tangents). For example, substrates of the plurality of substrates can be alumina ribbon ceramics. Additionally, having an antenna as part of the laminate (as antenna-in-packaging) can facilitate assembly (e.g., reducing the number of components that need to be precisely aligned in final assembly of a consumer electronic device) and/or facilitate miniaturization of the electronic components (including increasing an operating frequency to within one or more of the above- mentioned bands). Optionally, the laminate can further include a dielectric layer that can provide environmental resistance (e.g., moisture resistance and/or chemical resistance) to the metallic traces, for example, to enable reliable operation in harsh environments.

Methods of making the laminate (e.g., antenna-in-packaging) can alternately disposing a metallic trace on a substrate (and with one or vias in the substrate) and disposing another substrate thereon. In aspects, disposing the metallic trace can comprise disposing a conducting ink that is subsequently heated to form electrical connection through the laminate as well as (at least partially) bond the substrates (e.g., adjacent pairs of substrates) in the laminate together. In aspects, disposing the metallic trace can comprise aerosol jet printing and/or metal organic decomposition to provide a dense metallic trace, high electrical conductivity, and/or a distinctive microstructure.

What is claimed is:

1. A laminate comprising:
a plurality of substrates including a first substrate and a second substrate, a substrate material of the plurality of substrates comprising an electrical conductivity at 20° C. of about 10S/m or less;
a plurality of metallic traces including a first metallic trace, a second metallic trace, and a via, the first metallic trace disposed on the first substrate, the second metallic trace disposed on the second substrate, the via electrically connecting the first metallic trace and the second metallic trace through the second substrate, a metallic material of the plurality of metallic traces comprising an electrical conductivity at 20° C. of about 10⁵ S/m or more,
wherein the first substrate and the second substrate are bonded together by at least the first metallic trace.

2. The laminate of claim 1, wherein a substrate thickness of the second substrate is from about 10 micrometers to about 800 micrometers.

3. The laminate of claim 1, further comprising a plurality of dielectric layers, a dielectric layer of the plurality of dielectric layers positioned between the first substrate and the second substrate, a dielectric material of the plurality of dielectric layers comprising an electrical conductivity at 20° C. of about 0.1 S/m or less;
and at least one of:
the dielectric layer contacting the first metallic trace; or
the dielectric layer positioned at a peripheral location between the first substrate and the second substrate.

4. The laminate of claim 3, wherein the plurality of dielectric layers comprises an adhesive.

5. The laminate of claim 3, wherein the dielectric material comprises a dielectric loss tangent of about 0.01 or less at 20° C. and 20 GHz.

6. The laminate of claim 1, wherein the metallic material of the plurality of metallic traces comprises copper, silver, gold, aluminum, nickel, platinum, or alloys with or without conductive carbon or combinations thereof.

7. The laminate of claim 1, wherein an average grain size of the metallic material of the plurality of metallic traces is from about 10 nm to about 800 nm.

8. The laminate of claim 1, wherein the electrical conductivity of the substrate material at 20° C. is about 10⁻⁶ S/m or less, and the substrate material exhibits a dielectric loss tangent of about 0.01 or less at 20° C. and 20 GHz.

9. The laminate of claim 1, wherein the substrate material comprises alumina, zirconia, steatite, quartz, or a glass-based material.

10. The laminate of claim 1, wherein the plurality of metallic traces include an antenna configured to receive or transmit signals comprising a frequency from about 20 GHz to about 400 GHz.

11. The laminate of claim 10, wherein the plurality of metallic traces further comprises a ground, the plurality of metallic traces further configured to transmit the signals between an integrated circuit and the antenna, the ground positioned between the integrated circuit and the antenna.

12. A consumer electronic device comprising:
an antenna-in-packaging comprising the laminate of claim 1;
an integrated circuit in electrical contact with the antenna of the laminate through the plurality of metallic traces, and a ground of the laminate positioned between the integrated circuit and the antenna of the laminate.

13. A consumer electronic device comprising:
a housing comprising a front surface, a back surface, and a side surface; and
electrical components at least partially within the housing, the electrical components comprise a controller, a memory, and a display, the display at or facing the front surface of the housing,
wherein at least one of the electrical components or the housing includes the laminate of claim 1.

14. A method of making a laminate comprising:
disposing a first metallic trace on a first substrate;
disposing a second substrate on the first metallic trace;
disposing a second metallic trace on the second substrate and within a via in the second substrate; and
heating an assembly comprising at least the first substrate, the second substrate, the first metallic trace, and the second metallic trace to form the laminate with the first substrate bonded to the substrate by a least the first metallic trace, and the first metallic trace in electrical contact with the second metallic trace,
wherein a substrate material of at least one of the first substrate or the second substrate comprises an electrical conductivity at 20° C. of about 10 S/m or less, a metallic material of at least one of the first metallic trace or the second metallic trace comprises an electrical conductivity at 20° C. of about 10⁵ S/m or more, and the disposing the first metallic trace and the second metallic trace comprises disposing a conductive ink that forms the corresponding metallic trace.

15. The method of claim 14, wherein the metallic material comprises copper, silver, gold, aluminum, nickel, platinum, or alloys with or without conductive carbon or combinations thereof, and an average grain size of the metallic material of the plurality of metallic traces is from about 10 nm to about 800 nm.

16. The method of claim 14, wherein the disposing the first metallic trace comprises aerosol jet printing.

17. The method of claim 16, wherein the disposing the first metallic trace further comprises metal organic decomposition.

18. The method of claim 14, wherein the disposing the first metallic trace occurs at a first temperature from about 60° C. to about 350° C., and the heating the assembly comprises heating the assembly at a second temperature from about 150° C. to about 350° C. for a second period of time from about 10 minutes to about 2 hours.

19. The method of claim 14, further comprising, before disposing the second substrate, disposing a dielectric layer on the first substrate, a dielectric material of the dielectric layer comprises an electrical conductivity at 20° C. of about 0.1 S/m or less.

20. The method of claim 14, wherein the dielectric material comprises a dielectric loss tangent of about 0.01 or less at 20° C. and 20 GHz, a substrate thickness of the second substrate is from about 10 micrometers to about 800 micrometers, the electrical conductivity of the substrate material at 20° C. is about 10⁻⁶ S/m or less, and the substrate material exhibits a dielectric loss tangent of about 0.01 or less at 20° C. and 20 GHz.
